(19) United States
(12) Patent Application Publication
(10) Pub. No.: US 2026/0300715 A1
(43) Pub. Date: Oct. 1, 2026

(54) DIFFUSION MODEL TRAINING

(71) Applicant: Microsoft Technology Licensing, LLC, Redmond, WA (US)

(72) Inventors: Fabian Maximilian FALCK, Oxford (GB); Sushrut KARMALKAR, Cambridge (GB); Richard Eric TURNER, Cambridge (GB); Javier ZAZO RUIZ, Cambridge (GB); Edward William Frederick MEEDS, Cambridge (GB); Kiarash ZAHIRNIA, Cambridge (GB); Rachel Shannon LAWRENCE, Cambridge (GB); Teodora Plamenova PANDEVA, Cambridge (GB)

(21) Appl. No.: 19/096,437

(22) Filed: Mar. 31, 2025

(51) Int. Cl. G06N 3/08

(52) U.S. Cl. CPC G06N 3/08

(57) ABSTRACT

Certain aspects herein relate to iterative noising or denoising in diffusion models. According to one aspect herein, a forward process systematically introduces noise by transforming each training sample into a frequency representation and injecting frequency-specific perturbations based on a measured variance per band. According to another aspect herein, a reverse process starts from an initially noisy frequency-domain representation—also scaled to match known variances—and iteratively refines it toward a generated output. Both processes rely on frequency-aware transformations to modulate or restore data across multiple frequency bands, proceeding in opposite directions yet built on the same core principle of operating in the frequency domain using variance-based scaling.

### TECHNICAL FIELD

The present disclosure pertains to generative artificial intelligence, and in particular to improved mechanisms for training diffusion models, with consequent improvements over a range of applications such as image generation, audio generation, or the synthesis of molecular structures.

### BACKGROUND

Machine learning (ML) has emerged as a core discipline in modern computing, enabling automated inference and prediction across numerous tasks. With advances in generative artificial intelligence (AI) approaches, models can produce new data samples that synthesize real-world signals, including images, audio, and molecular structures, among other modalities.

Diffusion models are a form of “iterative” neural network widely used for generative tasks, including image synthesis, text-to-image generation, audio inpainting, and, or protein structure modeling. Such models are trained by sequentially adding noise to training data. The diffusion model then learns to remove the noise from the training data, or equivalently learns to predict the clean training data given a noisy training data. In turn, this learns a reverse process of a diffusion model which traverses from noise to clean data and hence allows generation of data. In some diffusion models (such as the DDPM approach), the noising and denoising happens directly in the data space (e.g., pixel space for images), while in so-called ‘Latent Diffusion Models’, an encoder first transforms the data into a lower-dimensional latent representation, where the diffusion steps are applied. The training process optimizes the weights of the diffusion model to minimize overall discrepancy between the original training data points before adding noise and the model prediction (in the case of predicting the data input). At inference, the trained diffusion model operates on a noise input, which is successively denoised to produce a generated output, using only the reverse process.

Inference involves successive denoising, whereby signals are successively denoised but with a small amount of sampled noise added after each denoising. Denoising Diffusion Probabilistic Models (DDPM) is the original diffusion framework, where samples are generated by iteratively reversing a noisy, Markovian forward process, typically incorporating small amounts of noise at each reverse step. DDIM (Denoising Diffusion Implicit Models) modifies this sampling procedure to be deterministic (in the most common variant), and is particularly efficient in terms of the number of reverse steps required during sampling. Put simply, DDPM follows a fully probabilistic diffusion process, while DDIM offers a more deterministic route for sample generation.

Diffusion models have proven effective in extensive real-world applications, such as producing high-resolution imagery from text prompts, simulating intricate video sequences, or sampling from complex distributions in scientific domains. Central to their success is the balance between the forward noising step and the learned backward denoising, making diffusion models highly flexible and capable of capturing nuanced data characteristics.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Certain aspects herein relate to iterative noising or denoising in diffusion models. According to one aspect herein, a forward process systematically introduces noise by transforming each training sample into a frequency representation and injecting frequency-specific perturbations based on a measured statistic (e.g., variance) per band. According to another aspect herein, a reverse process starts from an initially noisy frequency-domain representation—also scaled to match known data statistics (e.g., variances)—and iteratively refines it toward a generated output. In some embodiments, a denoising model (e.g., neural network) which learns a reverse process is applied in data space where an architecture of the denoising model (e.g., specific neural network architecture) is known to have a beneficial inductive bias. Both processes rely on frequency-aware transformations to modulate or restore data across multiple frequency bands, proceeding in opposite directions yet built on the same core principle of operating in the frequency domain using variance-based scaling.

### BRIEF DESCRIPTION OF FIGURES

Example embodiments will now be described with reference to the following figures, in which:

FIG. 1 illustrates an iterative denoising model for inference.

FIG. 2 shows a training procedure that applies frequency-based noise injection to a transformed representation.

FIG. 3 depicts a sampling process for generating data from an initial noisy frequency-domain input.

FIG. 4 provides a comparison of generated outputs against real data in high-frequency regions.

FIG. 5 depicts an example computing environment for implementing the described model training or sampling techniques.

### DETAILED DESCRIPTION

Conventional diffusion models typically add Gaussian noise in the input domain at each forward step. In the case of images, this noise is applied directly to pixel values (in “pixel space”), but the same mechanism can be applied to any continuous data form in an input space of the data (e.g. pixel space, audio signal space etc.).

A novel sampling mechanism is described for improving diffusion modeling through an alternate forward process defined in Fourier space. Example embodiments incorporate the sampling mechanism in a training or fine-tuning process used to train or fine-tune a diffusion model. The sampling mechanism is based on the novel insight that standard diffusion models, such as DDPM, apply uniform noise addition in the input domain, which in turn produces a non-uniform degradation in the frequency domain of the input data. For example, when the signal variance of the data (e.g., as captured in a covariance matrix) exhibits a Fourier power law such that one low-frequency component possesses a significantly higher variance than the corresponding high-frequency components, the latter is caused to be corrupted more rapidly. Example embodiments provide a modified noise addition scheme that equalizes the signal-to-noise ratio (SNR) across all frequencies, effectively counterbalancing the non-uniform degradation in the frequency spectrum of the input data with non-uniform scaling across the frequency spectrum of the noise.

Note, the term “training” herein is used in a broad sense, encompassing not only training of a model “from scratch”, but also fine-tuning of an existing trained model, e.g. to modify some or all of its parameters or to fine tune one or more augmentation layers added to the trained model.

This improved frequency-aware diffusion approach yields tangible benefits over a range of applications. For image generation, it reduces artifacts that arise from unevenly corrupted frequency components, resulting in more realistic fine details. Objective, measurable discrepancies between synthetic and real imagery are reduced (that is, measurable noise/artifacts, distinct from mere semantic image content), with the consequent ability to generate higher fidelity images with less distributional divergence. In audio generation, uniformly scaling noise across the frequency domain preserves essential harmonics and transient features, leading to outputs with greater clarity. For other modalities, such as volumetric data or protein structures, these techniques maintain structural coherence in both low- and high-frequency bands, producing samples that more faithfully mirror true data distributions. In sum, by aligning noise injection with the statistical properties of each frequency band, the method improves the quality of generated data as measured in term of objective signal properties in the application domain. This improvement in generated data quality is achieved by mitigating high-frequency distortions during training/fine tuning of a diffusion model, substantially improving the preservation of critical details in data generated with the trained diffusion model.

A trained diffusion models can be applied to an extensive variety of technical data generation tasks. These include generating synthetic images for medical diagnostics that preserve characteristic patterns while obfuscating private patient information, synthesizing near-infrared or spectral imagery to simulate remote sensing data for agricultural or environmental analyses, and producing augmented data for robotic simulations, where diverse sensor inputs and camera views must be replicated to refine navigation and control algorithms. In bioinformatics, a diffusion model may produce new, structurally consistent protein conformations, assisting in drug design or enzyme engineering. In fluid dynamics, it may generate simulated flow fields for aerodynamic testing and turbulence modeling. Monte Carlo-style physics experiments, such as particle collision simulations, can also benefit from diffusion-based sample generation to reduce computational costs while broadening training datasets. Audio domains encompass tasks like generating synthetic voice samples for speech recognition system optimization, producing musical audio for composition tools, and synthesizing ambient environmental signals for sound design. Extended applications exist for speech enhancement, medical ultrasound image modeling, 3D rendering of complex scenes, and artificial generation of volumetric or LiDAR point cloud data or other forms of sensor data. Other applications include video generation (diffusion models have wide applications in video synthesis), and general-domain image generation such as text-to-image in the (e.g. in the content of chat systems). Other applications include data synthesis for astronomy, histopathology or dynamical systems (e.g. robotics).

The aforementioned technical applications (among others) benefit from the improved training mechanism described herein, which ensure that high-frequency details are reliably captured at training and therefore generated with greater fidelity at inference.

Many real-world data types—images, videos, audio signals, volumetric structures, and more—can be modeled as elements of a continuous vector space over the real numbers. Concretely, a color image of spatial size H×W can be vectorized into [symbol] ^{3HW} (where 3 is the number of channels), a snippet of audio can be represented by waveform samples in [symbol] ^{N}, and similarly for other continuous data modalities. Each of these data forms is said to inhabit an ‘input space’, wherein each component or dimension corresponds to a real value measuring intensity, amplitude, or an analogous continuous quantity. These continuous representations then lend themselves to a Fourier transform F, a linear mapping into ‘Fourier space’. This transformation decomposes the original data into frequency components, enabling analysis and processing of signal magnitude and phase at distinct frequencies. The described embodiments leverage this transform to precisely modulate the noise introduced at different frequencies during diffusion model training, leveraging the insight that, for many forms of real-world data, the power spectrum often follows a pronounced decay from low to high frequencies.

An important aspect of the novel processing is how the insights concerning non-uniform noising are exploited in practice. Based on the insight that data in the input space often exhibits relatively large variation at low frequencies (and correspondingly smaller variation at higher frequencies), the framework introduced herein makes active use of the Fourier transform to apply frequency-dependent scaling during the forward diffusion process. This refined form of diffusion ensures the variance added to each frequency band is proportional to the band's typical energy or variance in the real-valued data. Mathematically, if Σ∈ [symbol] ^{d×d} denotes a diagonal covariance matrix whose diagonal elements Σᵢᵢ reflect an empirical frequency variance of real data, a forward step yₜ=\sqrt{α̅ₜ} y₀+\sqrt{1−α̅ₜ} ϵ_{Σ} takes place in the transformed (Fourier) domain (in contrast to conventional diffusion applied in the input space of the data), with ϵ_{Σ}~ [symbol] (0, Σ). This ensures that each frequency component is noised according to its inherent scale in real data; in other words, less noise is assigned to those components with naturally smaller magnitudes in Fourier space. In turn, a reverse process trained to denoise these frequency-specific corruptions is trained to generate the data more uniformly across different scales of detail, enhancing the fidelity of samples for high-frequency textures as well as for broader low-frequency structure.

In conventional diffusion processes, the forward method is defined by sequentially adding Gaussian noise where the SNR depends on both the mixing coefficients and the inherent signal variance in Fourier space. Through signal processing analysis, it is demonstrated that, because of the Fourier power law, one or more high-frequency components attain a low signal-to-noise ratio (SNR) at an earlier stage compared with one or more low-frequency components, thereby challenging the Gaussian assumption assumed for the reverse process. To address these challenges, certain embodiments provide an alternative process, referred to herein as “EqualSNR”, which enforces a uniform SNR across all frequencies by scaling the noise variance in proportion to intrinsic signal variance. This approach mitigates frequency-wise discrepancies and improves the quality of the generated outputs.

Expanding on the above, in a conventional forward diffusion setup, one data point x₀ from [symbol] ^{d} is drawn from a distribution p(x₀). The forward process generates a sequence of latent variable:

$${\{ {x}_{t} \}}_{t = 1}^{T} ,$$

each defined by:

$$q ( {x}_{t} \vert {x}_{t - 1} ) = ( {x}_{t} ; \sqrt{1 - {α}_{t}} {x}_{t - 1} , {α}_{t} I )$$

where αₜ represents a noise-level parameter. A marginal distribution of xₜ given x₀ then becomes:

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I )$$

in which

$${\overline{α}}_{t} = {\prod }_{s = 1}^{t} ( 1 - {α}_{s} ) .$$

A reparameterization expresses xₜ explicitly as:

$${x}_{t} = \sqrt{{\overline{α}}_{t}} {x}_{0} + \sqrt{1 - {\overline{α}}_{t}} ϵ , ϵ ∼ 𝒩 ( 0 , I ) .$$

To investigate how this forward process behaves, one may rewrite xₜ in the frequency domain by applying a suitable Fourier transform F. Let yₜ=Fxₜ. By linearity, one obtains:

$${y}_{t} = \sqrt{{\overline{α}}_{t}} {Fx}_{0} + \sqrt{1 - {\overline{α}}_{t}} F ϵ ,$$

which shows that a high frequency component of the data having a comparatively small variance can be corrupted more quickly. One describes this corruption via a Signal-to-Noise Ratio (SNR) defined for each frequency coordinate i:

$$SNR ( {( {y}_{t} )}_{i} ) = \frac{{\overline{α}}_{t} Var ( {( {y}_{0} )}_{i} )}{1 - {\overline{α}}_{t}} ,$$

Aggressive noising of high frequencies can cause the posterior q(yₜ₋₁|yₜ) to deviate from Gaussianity. This can lead to inaccuracies when assuming a Gaussian for reversing the process.

By enforcing a noise variance scaled by a variance of each frequency band, a modified forward approach maintains the same SNR across spectral components. One way to accomplish this is to rescale noisy representation so the ratio of signal variance to noise variance remains uniform across all frequencies. This strategy disrupts the low-to-high frequency hierarchy and improves the fidelity of high-frequency generation in the reverse pass compared to conventional diffusion modeling.

In the above, Var denotes variance, y₀ denotes a frequency-domain representation of data sample x₀ and (y₀)ᵢ denotes an ith component of the frequency-domain representation y₀.

Example embodiments provide a comprehensive framework that includes adapted training and sampling algorithms to operate in Fourier space under the EqualSNR principle. A novel training procedure revises conventional diffusion model loss functions by integrating scaling factors derived from the square root of the signal variance, and ensure that the loss remains a valid evidence lower bound of the data marginal likelihood. The associated deterministic sampling algorithm, adapted from established DDIM techniques, enables simultaneous generation of all frequency components without imposing a hierarchy. Calibration among different forward processes is achieved by properly selecting the mixing coefficients so that the average SNR across frequencies remains constant at each stage. This technical framework is particularly beneficial in applications where high-frequency details play a critical role, as exemplified in imaging and other related domains.

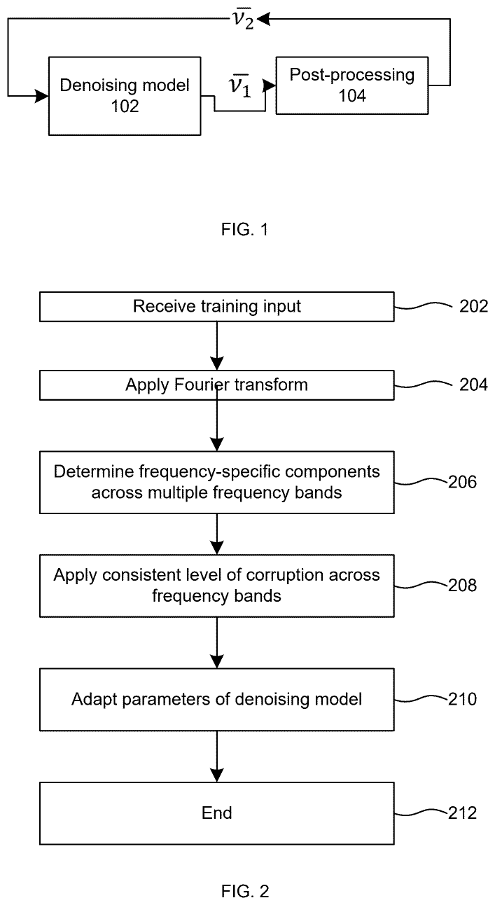

FIG. 1 shows a highly schematic block diagram of an example diffusion model implementation at inference, incorporating a reverse noise sampling process. As discussed, a diffusion model is a form of iterative neural network, in which model outputs are iteratively generated and refined in a feedback loop. FIG. 1 depicts a trained denoising model 102, which is a machine learning model that has been trained to perform denoising. The diffusion model is applied at inference via multiple iterative applications of the denoising model 102, resulting in successive incremental denoising steps that transform a noisy input, such as “pure” noise, to a synthesized output (e.g. image, audio etc.). The term “denoising” reflects the concepts of iteratively restoring a signal from noise, noting that, at inference, the output signal is entirely synthesized from pure input noise based on data patterns captured in the weights of the denoising model 102 at training.

At the hardware level, the denoising model 102 can be implemented in a variety of ways. For a digital domain implementation, the denoising model 102 is in some examples implemented on a general-purpose processor (such as a CPU or an accelerator processor such as a GPU, TPU etc.). Increasingly, as the adoption of such models increases, bespoke or semi-bespoke hardware implementations are being developed, both digital (such as implementations using field-programmable gate arrays or application-specific integrated circuits) and, increasingly, analog hardware (such as optical diffusion models).

The denoising model 102 performs matrix operations on input vectors based on encoded parameters of the denoising model 102. Blocks 104 represents optional intermediate processing between receiving an output of the model 102 and feeding the output back into the model 102, such as a noise injection process (some diffusion approaches optionally reintroducing a controlled level of noise after each partial denoising step. This maintains a stochastic element during inference, enabling to improved data distribution capture during inference).

The post processing 104 is followed by another iteration through the model 102. From left to right, FIG. 1 represents a first iteration through a denoising model 102, resulting in an output vector v̅₁, then an (optional) noise injection process 104 wherein noise is added to the produce a modified output vector v̅₂. The modified output vector v̅₂ is then passed in a feedback loop back into the denoising model 102 for a second iteration of the model. Without post-processing, the output of the model 102 is fed back to it directly as its next input, meaning v̅₁=v̅₂. Over time, after multiple iterations of the denoising model 102, the output vector of the denoising model 102 converges on a final output when a fixed maximum number of iterations is reached.

FIG. 1 shows a high-level block diagram outlining the principles of diffusion model implementation. Other steps than those represented in the drawing may also be taken. Non-linearity operations, for instance, may be implemented to normalize output vectors.

To improve performance of a trained diffusion model (such as that of FIG. 1) at inference, improved training mechanisms are provided herein.

FIG. 2 shows a schematic flowchart for a single training iteration of a method of training a diffusion model, incorporating a forward process. The training iteration begins at step 202 by receiving a training data sample, such as an image, volumetric data, or other continuous modality, in its native input space. At step 204, the procedure applies a Fourier transform to convert the input into a frequency-domain representation.

Next, at step 206, noise is injected by generating a base distribution noise ϵ_{C}, which is a set of frequency-specific noise components (ϵ_{C})ⱼ, where j denotes the component for a particular frequency band. Each component is each drawn from a complex normal distribution scaled to match an associated variance of the frequency band. Concretely, for each frequency band, the real and imaginary parts are provided by independent draws from [symbol] (0,1), then scaled by the square root of that band's empirical variance to match the typical magnitude observed in real-world data.

At step 208, a Signal-to-Noise Ratio (SNR) schedule is applied to further modulate the base distribution noise, adjusting their amplitude so that overall corruption at each frequency band consistently aligns with a desired per-band SNR profile. Thus, step 208 builds on the interim scaling from step 206 to establish a final noise level for each band. The SNR schedule dictates how strongly noise is applied relative to the underlying signal at each step of the forward noising process. By maintaining a particular ratio of signal to noise across different frequency bands (e.g., low-vs. high-frequency components), the model can learn to denoise each part of the data spectrum with balanced exposure to corruption. This systematic approach helps the model develop a denoising function that is effective across all frequencies, rather than disproportionately learning to handle certain (e.g., lower-frequency) bands.

At step 210, a resulting degraded frequency-domain representation is passed into a denoising model that is trained to predict the original clean sample. This denoising model constitutes the primary trainable component within a diffusion-based framework, (sometimes referred to as a noise predictor or score function) and is tasked with inverting the forward noising process by estimating how to remove the injected disturbances. The frequency-specific components (ϵ_{C})ⱼ are internally preserved so that the difference between the distorted data and the model's recovered output can serve as a supervised learning signal, allowing the procedure to quantify how accurately the denoising model reconstructs the underlying signal.

At step 212, the training iteration concludes, delivering updated model parameters that reflect the training iteration under these frequency-domain guidelines, thereby refining the model's ability to remove noise in subsequent iterations.

Although the flowchart in FIG. 2 outlines the major steps just once in respect of a single training input, in practice, these steps are repeated across multiple (e.g., many) training iterations with multiple (e.g. many) training inputs. Each iteration takes a new (or augmented) sample, applies the noising procedure (using the chosen SNR schedule), and trains the model to predict the clean output from its noisy counterpart. After each iteration, the model weights are updated accordingly (step 212), and the process begins again with another sample or another level of noise, thereby allowing the diffusion model to gradually learn an effective denoising function over repeated passes.

In each training iteration, a training sample is transformed into a frequency-based representation and noised according to the chosen schedule. The diffusion model then estimates a clean representation by inferring uncorrupted frequency components. A difference metric (loss), such as mean squared error between the model's prediction and an original non-noisy frequency distribution, quantifies the error. This loss indicates how closely the model approximates the clean representation at every iteration (step 210 in FIG. 2). By iteratively updating model parameters to reduce this loss, the procedure converges, for example, when further refinements yield negligible improvements in restoring high- and low-frequency details, or on reaching some maximum number of iterations. Consequently, a final set of parameters is obtained that consistently reconstructs data with minimal discrepancy relative to the original, uncorrupted signal.

As used herein, “variance” refers to statistical variance of a frequency component in the data, measured prior to any artificially introduced noise. This realizes the idea of mitigating the uneven degradation of high-frequency details by revealing the inherent energy level in each band when applying frequency-specific noise injection to preserve subtle signal information in higher frequency bands.

“Frequency-specific degradation” refers to introducing noise at each frequency band in proportion to that band's variance. In the present example, this frequency-specific degradation is achieved through the combination of steps 206 and 208.

The term “clean representation” is used to refer to original, uncorrupted frequency components of a sample (which the diffusion model is trained to reconstruct at step S210), whilst “Fourier domain” denotes a transformed space where signals are expressed in terms of their constituent frequencies rather than direct spatial or temporal samples. At each iteration, the diffusion model is applied to the degraded frequency representation, and generates an output representation therefrom. Parameters (e.g., weights) of the diffusion model are adjusted based on the loss to match the generated frequency representation to the original clean frequency-domain representation.

An example implementation of the method of FIG. 2 is set out below in pseudo-code as Algorithm 1.

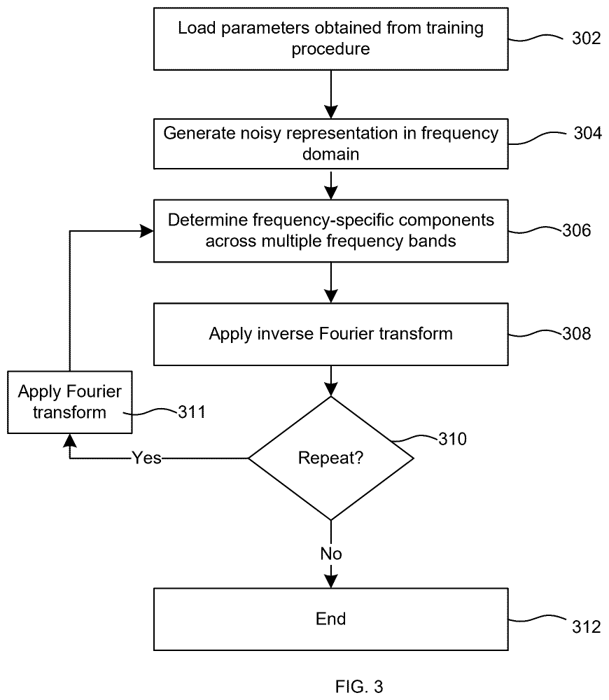

FIG. 3 shows a schematic flowchart for a method of sampling a trained diffusion model incorporating a reverse process. At a high level, in some examples, the procedure depicted in FIG. 2 provides the trained diffusion model parameters that are then used by the method in FIG. 3 for sampling or generation at inference.

As step 302, the method commences by loading the parameters obtained from the training procedure.

At step 304, an initial noisy representation (e.g., an initial pure noise input) is generated in the frequency domain across multiple frequency bands, using draws from a normal distribution scaled according to a variance of each frequency band. This involves applying a first frequency-specific degradation to a first frequency band a variance of the first frequency band (first variance), and a second frequency-specific degradation to a second frequency band based on a variance of the second frequency band (second variance). With more than two frequency bands (e.g. third, fourth etc.), a frequency-specific degradation is applied to each such band based on that band's variance. When the training procedure (described above) has been used, this initial scaling of the frequency bands (or rather their distribution) is correspondingly performed at inference. The denoising model (e.g., neural network) has been trained, through the above training algorithm, to denoise in a different way, and is then used during inference, together with the described inference procedure of FIG. 3, which samples from a different initial distribution in the first step.

Next, at step 306, the trained model executes a reverse denoising pass, iteratively refining the frequency components in the frequency domain, per band, to diminish noise while recovering fine structure. Whereas in the forward process of FIG. 2, frequency-specific degradation is applied across frequency bands, in the reverse process of FIG. 3, a frequency-specific denoising is applied across frequency bands.

At step 308, the process applies an inverse Fourier transform, merging real and imaginary parts across all frequency bands, reversing any scaling introduced earlier, and reassembling the data in the original input space.

If additional refinement is warranted at step 310, the flow returns the data to the frequency domain (applying a Fourier transform at step 311) and repeats the denoising and inverse-transform cycle, ensuring that each round of processing further reduces residual noise in proportion to the known signal variance.

Ultimately, at step 312, a final reconstructed sample is produced in the original domain. This approach preserves high-frequency details in a uniform manner, ensuring consistent regeneration across different spectral components. The procedure terminates at step 312.

An example implementation of the method of FIG. 3 is set out below in pseudo-code as Algorithm 2, which implements the approach of FIG. 3 in an adapted DDIM sampling algorithm.

In summary, the training procedure transforms the data into (complex) Fourier space and applies a rescaled loss that addresses frequency-specific variance. An important element is the use at training of the base distribution noise (ϵ_{C})ⱼ which denotes the j-th component of the complex normal noise in the Fourier domain, scaled by the corresponding frequency-specific covariance. By introducing noise proportional to each frequency's inherent scale, the corruption is more uniformly distributed across frequencies. Once the forward noising has been applied in Fourier space, the neural network is then trained to reconstruct the original input y₀. During sampling, the method inverts the denoised frequency representation back into the input space, ensuring minimal uneven corruption in high-frequency details. This approach preserves structure in both low- and high-frequency components by reverting through the inverse Fourier transform. Meanwhile, appropriate calibration maintains a consistent SNR profile across frequencies, as previously discussed, allowing for faithful reconstructions of intricate details in scenarios requiring high-resolution outputs.

Specific implementations will now be described in further detail, by way of example only. Additional analysis is also provided, which demonstrates the efficacy of the described techniques.

As discussed, diffusion models are the state-of-the-art generative model on data modalities such as images, videos, proteins, and materials. They excel on a wide range of tasks and applications on these modalities, such as generating high-resolution images and videos given a text prompt, sampling the distribution of conformational states of proteins, or generating novel materials under property constraints. It is useful to question why diffusion models work so well on these modalities, possibly even surpassing the performance and efficiency of autoregressive models. This question is considered herein via the forward (or noising) process of diffusion models in Fourier space. The forward process of standard diffusion models such as DDPM corrupts data by progressively adding white Gaussian noise until all information is destroyed (white noise has equal variance across all frequency components). Diffusion models then learn a denoiser which reverses this forward process by starting from Gaussian noise and iteratively refining it to approximate the original data.

While one might assume that the forward process destroys all information in data uniformly, this is not the case. In fact, for the modalities mentioned above, a DDPM forward process does not treat all frequency components equally. These modalities have in common that they exhibit a power law in their Fourier representation: low-frequency components have orders of magnitudes higher variances (and magnitudes) than high-frequency components. This data property has two important implications: The DDPM forward process noises high-frequency components both substantially faster, and earlier than low-frequency components, which we will discuss in and theoretically characterize with the Signal-to-Noise Ratio (SNR) (see). Intuitively speaking, the forward process in DDPM corrupts the high frequency information—the fine details such as edges—in fewer timesteps than low-frequency features, such as the larger structures and overall color of an image (see for an illustration). What is the inductive bias of this forward process on the learned reverse process?

In theory, with unlimited resources and arbitrarily accurate estimates of the scores of the noised distributions, diffusion models can learn to express any continuous distribution. In practice, however, diffusion models are constrained, for instance by a limited number of intermediate steps (discretisation) and the expressiveness of the neural network (score estimation), resulting in approximation errors. Since DDPM applies noise more aggressively to high-frequency components, corrupting them in fewer steps, one insight herein is that their approximation error is larger, resulting in a lower generation quality. As a result, DDPM prioritises low-frequency components within its resource constraints.

The forward process also imposes a hierarchy of the frequencies during generation: as the generative process learns to reverse the forward process (which in DDPM and on the modalities of interest noises high frequencies before low frequencies), the reverse process generates low frequencies first, and generates high frequencies conditional on low frequencies.

The forward process of diffusion models on data exhibiting the Fourier power law is considered, as is its effect on the learned reverse process in Fourier space. The impact of noising rate and hierarchy on the assumptions of the reverse process, and in turn on generation quality in diffusion models, is considered.

### A Spectral Analysis of DDPM

It is informative to consider how the DDPM forward process affects the frequencies of a signal. It is demonstrated below that high-frequencies are corrupted more aggressively, and substantially faster than low-frequency ones. This effect can be quantified in terms of the Signal-to-Noise Ratio (SNR).

Given a data point x₀∈ [symbol] ^{d} drawn from a data distribution whose density is given by p(x₀), the DDPM forward process generates a sequence of latent variables

$${\{ {x}_{t} \}}_{t = 1}^{T}$$

which satisfy the following transitions:

$$q ( {x}_{t} \vert {x}_{t - 1} ) = 𝒩 ( {x}_{t} ; \sqrt{1 - {α}_{t}} {x}_{t - 1} , {α}_{t} I ) ,$$

where αₜ controls the amount of (white) noise added at each timestep t, which is equal for all data dimensions. The marginal distribution of xₜ given x₀ is then obtained in closed form:

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I ) ,$$

with

$${\overline{α}}_{t} = {Π}_{s = 1}^{t} ( 1 - {α}_{s} ) .$$

This can be reparameterized as

$${x}_{t} = {\underbrace{\begin{matrix}\sqrt{{\overline{α}}_{t}} {x}_{0} & \end{matrix}}}_{signal} + {\underbrace{\begin{matrix}\sqrt{1 - {\overline{α}}_{t}} & \end{matrix}}}_{noise} ϵ , ϵ ∼ 𝒩 ( 0 , I ) ,$$

where the first term on the right-hand side is the (scaled) signal, the second term is the (scaled) noise.
DDPM corrupts high-frequencies more aggressively and earlier. Focusing on data modalities where diffusion models achieve state-of-the-art performance, such as images, video, proteins, and materials, such modalities share the property that—when viewed in their Fourier representation—their signal variance (and magnitude) decays with frequency by orders of magnitude. This data property is referred to that the Fourier power law henceforth. This property has two implications: fine details (high frequencies) are corrupted more aggressively, and before larger structures (low frequencies) during the forward process.

To see this, it is useful to view the DDPM forward process equivalently under a change of basis to the Fourier space. This is accomplished by applying the Fourier transform F to the latent variables xₜ as:

$$\begin{matrix}{y}_{t} := {Fx}_{t} = F ( \sqrt{{\overline{α}}_{t}} {x}_{0} ) + F ( \sqrt{1 - {\overline{α}}_{t}} ϵ ) \\ = {\underbrace{\begin{matrix}\sqrt{{\overline{α}}_{t}} {Fx}_{0} & \end{matrix}}}_{signal s} + {\underbrace{\begin{matrix}\sqrt{1 - {\overline{α}}_{t}} & \end{matrix}}}_{noise n} Fϵ\end{matrix}$$

by linearity, and n~ [symbol] (0, F(1−α̅ₜ)IF^{†})= [symbol] (0, (1−α̅ₜ)I), where F^{†} is the adjoint of F and noting that yₜ is complex-valued (see for details on this calculation). Since F is invertible, there is a one-to-one correspondence between a DDPM forward process in Euclidean (or pixel) space in and in Fourier space in, rendering these equivalent, alternative viewpoints.

The corruption of the signal is qualified with a Signal-to-Noise Ratio (SNR). Let s and n be two random variables with realisations in [symbol] , and f(s, n)=s+n be a measurement process. The Signal-to-Noise Ratio (SNR) is defined as

$$SNR ( f ) = \frac{Var [ s ]}{Var [ n ]} ,$$

where Var(s):=Var(Re(s))+Var(Im(s)) (and likewise for n). For d-dimensional random vectors s, n, we abuse notation and define SNR(f) entry-wise: SNR(f)ᵢ=SNR(fᵢ).

The SNR of (yₜ)ᵢ in, meaning the SNR of frequency i (or band i) at timestep t is computed as:

$${s}_{t}^{D D P M} ( i ) : = S N R ( {( {y}_{t} )}_{i} ) = \frac{{\overline{α}}_{t} {C}_{i}}{1 - {\overline{α}}_{t}}$$

where Cᵢ:=Var((y₀)ᵢ) represents the signal variance of frequency i which decays rapidly with frequency for our data modalities of interest. Implications of the Fourier power law property are formalized as follows. Firstly, the SNR of low frequencies is orders of magnitudes higher than the SNR of high frequencies at all timesteps under a DDPM forward process. In other words, a DDPM forward process does not ‘noise all frequencies equally’. Relative to the signal, the white noise of the DDPM forward process, which is equal for all frequencies, corrupts high-frequency information more aggressively, i.e. in fewer timesteps.

The Fourier power law further imposes a hierarchy onto the forward process where high frequencies attain a low SNR much earlier than low frequencies. As the generative process of diffusion models reverses the forward process, low-frequencies are generated earlier than high-frequencies, which can be viewed as being generated conditional on the former (see for an illustration). The effect of the more aggressive and earlier noising of high frequency information in DDPM on the learned reverse process and its generative performance is considered.

To alleviate the problem of poor quality high frequencies generated with DDPM, the alternate EqualSNR forward process is provided. This has important implications for applications where high-frequency details are the key modelling objective, such as astronomy or medical imaging, and DeepFake technology.

Consequences of the insight that high frequencies are noised faster than low frequencies in DDPM are considered. Under limited resources, the conventional Gaussian assumption of the reverse process is violated for high-frequency components. The alternate forward process in Fourier space and corresponding training and sampling algorithm alleviates the issue.

The stochastic reverse process of DDPM, iteratively denoises a (Fourier-transformed) iterate yₜ by sampling from the learned reverse process distribution p_{θ}(yₜ₋₁|yₜ) which approximates the intractable distribution q(yₜ₋₁|yₜ) in. A key assumption of the DDPM reverse process is that the distribution q(yₜ₋₁|yₜ) is Gaussian, leading to the design choice that p_{θ}(yₜ₋₁|yₜ) is Gaussian. In the limit of the total number of timesteps T tending to infinity, q(yₜ₋₁|yₜ) is known to converge to a Gaussian. However, in the practical setting of having a finite number of discretisation steps, this assumption only holds if the Gaussian noise added in the forward process q(yₜ|yₜ₋₁) is small enough relative to the signal variance. Under a DDPM forward process on data modalities with the Fourier power law, which adds noise of equal variance to all frequencies but has orders of magnitudes smaller signal variance in the high frequencies, or in other words a more aggressive noising of the high-frequency components, this may lead to significant violations of the Gaussian assumption in high-frequency components.

To see this formally, Bayes rule is applied:

$$q ( {y}_{t - 1} \vert {y}_{t} ) = \frac{q ( {y}_{t} \vert {y}_{t - 1} ) q ( {y}_{t - 1} )}{q ( {y}_{t} )} .$$

If the Gaussian distribution q(yₜ|yₜ₋₁) has a large variance relative to q(yₜ₋₁) and q(yₜ), which is the case for high frequencies in DDPM, fluctuations in the quantity

$$\frac{q ( {y}_{t - 1} )}{q ( {y}_{t} )}$$

are more apparent in the distribution q(yₜ₋₁|yₜ).

Proposition 1: For any sufficiently small δ<1, define D₀=1/2 [symbol] (−1, δ²)+1/2 [symbol] (1, δ²). Let xₜ₋₁~D₀ and let ε~ [symbol] (0, σ²), where σ=(log (1/τ)^{1/4}δ^{-1/2} δ. Then for the forward update, xₜ=xₜ₋₁+ε. The corresponding reverse distribution q(xₜ₋₁|xₜ) is at least at a total variation distance of 0.4 from any Gaussian.

Proposition 1 provides a counterexample to the assumption that the reverse process can be well-approximated by a Gaussian. It shows that starting with a mixture of two sufficiently separated Gaussians, with the addition of sufficiently large variance noise, then the distribution q(yₜ₋₁|yₜ) is far from any Gaussian (in fact, it also looks like a mixture of two Gaussians). For instance, in the case of CIFAR10 data, this happens for high frequencies since the variance of the noise added to the high frequency components is much higher relative to the variance of the data. For low frequency components on the other hand, since the variance of the data is large, this phenomenon does not occur.

### Alternate Forward Processes

Further details of the alternative EqualSNR forward process are described, in which the SNR of all frequencies is the same at every timestep. A second alternative forward process is also described, FlippedSNR, in which the SNR of the i^{th} frequency is the same as the SNR of the (d−i)^{th}, and which hence inverts the frequency hierarchy of DDPM during generation. EqualSNR addressed multiple practical challenges that conventionally inhibit diffusion model performance: first, it noises all frequencies at the same rate. EqualSNR enforces a ratio of the variance of q(yₜ|yₜ₋₁) and the variance of

$$\frac{q ( {y}_{t} )}{q ( {y}_{t - 1} )}$$

to be equal for all frequencies at each timestep. A Monte Carlo estimate of q(yₜ) and q(yₜ₋₁) is computed via push-forward in. Fluctuations in

$$\frac{q ( {y}_{t} )}{q ( {y}_{t - 1} )}$$

hence arrect an frequencies equally, and the Gaussian assumption of the reverse process in high-frequency components is no longer violated with similar distribution distances, overcoming this issue of DDPM. Second, both EqualSNR and FlippedSNR address the question whether low-to-high frequency generation is essential in diffusion models: EqualSNR, which we will focus on in, generates samples without any hierarchy among the frequencies, while FlippedSNR inverts the hierarchy of DDPM, generating frequencies from high to low.

Proposition 2: Let Cᵢ=Var[(y₀)ᵢ] represent the coordinate-wise variance in Fourier space, and let ϵ~ [symbol] (0, Σ). Suppose the forward process in Fourier space is given by yₜ=\sqrt{α̅ₜ}y₀+\sqrt{1−α̅ₜ}ϵ_{Σ}, with the SNR at timestep t and frequency i defined as

$${s}_{t} ( i ) = \frac{{\overline{α}}_{t} {C}_{i}}{( 1 - {\overline{α}}_{t} ) {Σ}_{i i}} .$$

This implies:
1. DDPM: The forward process for DDPM has SNR

$${s}_{t}^{D D P M} ( i ) = \frac{{\overline{α}}_{t} {C}_{i}}{( 1 - {\overline{α}}_{t} )} .$$

2. Equal SNR: The forward process has equal SNR across all coordinates if and only if Σᵢᵢ=cCᵢ, where c is a universal constant. The process is ‘variance-preserving’ (as in) when c=1. If Σ=cCov(y₀), the equal SNR property holds across all bases.

The forward processes are defined through their frequency-specific SNR sₜ(i) at time t, not the mixing coefficients (e.g. α̅ₜ). This is advantageous as it allows such a forward process to be applied to high-resolution data without modification.

Framework components used to train a diffusion model in Fourier space with these alternate forward process will now be described.

Algorithm 1 allows to train diffusion models with the alternate forward processes in Fourier space (in the variant predicting the clean sample). A key difference to standard DDPM training is that the noise and the difference in a loss [symbol] ₜ are scaled by the signal variances C^{1/2} in Fourier space. The loss [symbol] ₜ is an evidence lower bound (ELBO). A neural network f_{θ} is trained in the input space of the input data (e.g., pixel space), for example a U-Net in Euclidean/pixel space to maintain its inductive bias.

In the following algorithms, F denoted a Fourier transform (from the input space of the data to the frequency domain), whilst F⁻¹ denotes an inverse Fourier transform (from the frequency domain to the input space of the data).

Algorithm 1 (Fourier space noise):

```
Inputs:
  -  $‐ data samples S := {\{ {x}_{0}^{( i )} \}}_{i = 1}^{N} ,$
  - number of diffusion steps T,
  -  $‐ noise schedule {\{ \overline{{α}_{t}} \}}_{t = 1}^{T} ,$
  - neural network f_{θ}, number of training iterations M.
let C := Diag(Cov(y₀)) for M iterations do:
    (a) sample x₀ ~ S, y₀ = Fx₀, t ~ Uniform({1, ... , T}).
    $( b ) for each j in [ d / 2 ] , set {( {ϵ}_{C} )}_{j} = {( {ϵ}_{C} )}_{d - j} and ( {ϵ}_{C} ) j \sim ( {C}_{j}^{1 / 2} / \sqrt{2} ) ( ϵ + i {ϵ}^{′} ) , where$
    ϵ, ϵ′ ~ [symbol] (0,1).
    (c) Fourier forward process: yₜ = \sqrt{αₜ} y0 + \sqrt{1 − αₜ}  ϵC.
    (d) predict sample: ŷ₀ = (F ○ f_{θ})(F⁻¹(yₜ), t).
    (e) compute loss: [symbol] ₜ = ∥C^{-1/2}(y₀ − ŷ₀)∥².
    (f) update θ via gradient descent on [symbol] ₜ.
```

Algorithm 1 uses a dataset S with N training samples, a specified number of diffusion steps T, a noise schedule {αₜ}, a denoising model (e.g. the denoising model 102 of FIG. 1) in the form of a neural network f_{θ}, and a chosen number of training iterations M. A covariance matrix C is defined as Diag(Cov(y)) in Fourier space, where y is the frequency-domain representation of a sampled data point x. Here, Cov(y₀) is a full covariance matrix describing how the frequency components of y₀ vary and correlate across a training set S (that is, the covariance of frequency-domain representations of the training samples across the training set S). The operator Diag(Cov(y₀)) takes only the diagonal elements of that covariance matrix, producing a diagonal matrix whose entries reflect the variance of each frequency bin while discarding cross-frequency correlations.

The base distribution noise in Algorithm 1 ϵ_{C} control the Fourier forward process in the Frequency domain.

A random time step t is selected uniformly among the T steps. A complex-valued noise vector ϵ_{C} is generated by enforcing (ϵ_{C})ⱼ=(ϵ_{C})_{d-j} and sampling each (ϵ_{C})ⱼ from

$${c}_{j}^{1 / 2} \sqrt{2} ( ϵ + i {ϵ}^{′} ) ,$$

where ϵ and ϵ′ both follow [symbol] (0,1). The forward update of the diffusion process in Fourier space is expressed as yₜ=\sqrt{αₜ}y₀+\sqrt{1−αₜ}ϵ_{C}, producing a noisy version of y₀. The operator (F·f_{θ})(F⁻¹(yₜ), t) means applying an inverse Fourier transform F⁻¹ to yₜ, feeding that a resulting degraded sample (in the original input space) into the neural network f_{θ} at time t, then performing a forward Fourier transform F on the network's output, resulting in a denoised estimate ŷ₀=(F·f_{θ})(F⁻¹(yₜ), t). The network's output is a reconstructed sample, computed from the degraded sample, and transformed back into the frequency domain by F. A loss function Lₜ=∥C^{-1/2}(y₀−ŷ₀)∥² is computed based on a scaled difference between the original frequency-domain representation y₀ and the denoised estimate ŷ₀, and the network parameters θ are updated by gradient-based methods to minimize Lₜ, thereby training the neural network f_{θ} to reconstruct the original frequency-domain sample. For this reason, ŷ₀ is referred to as a reconstructed frequency-domain representation. This procedure balances different frequency components via multiplication by C^{-1/2}, which accounts for variance in each frequency band.

Algorithm 2 (adapted form of DDIM in Fourier space):

```
Inputs:
  - noise y_{T}: = ϵ_{C} where for each j in [d/2], (ϵ_{C})ⱼ = (ϵ_{C})_{d-j} and (ϵ_{C})ⱼ ~
    $( {C}_{j}^{1 / 2} / \sqrt{2} ) ( ϵ + i {ϵ}^{′} ) , with ϵ , {ϵ}^{′} ∼ 𝒩 ( 0 , 1 ) ,$
  - neural network f_{θ},
  -  $‐ noise schedule {\{ {α}_{c} \}}_{f = 1}^{T} ,$
  - sampling steps T.
for t from T down to 1 do:
    $( a ) predict sample : {\hat{y}}_{0}^{( t )} = ( F ∘ {f}_{θ} ) ( {F}^{- 1} ( {y}_{t} ) , t ) .$
    $( b ) {y}_{t - 1} = \sqrt{{α}_{t - 1}} {\hat{y}}_{0}^{( t )} + \sqrt{\frac{1 - {a}_{t - 1}}{1 - {a}_{t}}} ( {y}_{t} - \sqrt{{α}_{t}} {\hat{y}}_{0}^{( t )} ) .$
$return {F}^{- 1} {y}_{0}^{( 1 )} .$
```

Algorithm 2 set out a sampling approach for a diffusion model reverse process in a Fourier-based setting. First, an initial noisy frequency-domain representation, in the form of a noise vector y_{T}=ϵ_{C}, is generated so that (ϵ_{C})ⱼ=(ϵ_{C})_{d-j} and each (ϵ_{C})ⱼ follows

$${c}_{j}^{1 / 2} \sqrt{2} ( ϵ + i {ϵ}^{′} ) ,$$

with ϵ, ϵ′~ [symbol] (0,1).

Whereas in Algorithm 1, the base distribution noise ϵ_{C} controls the Fourier forward process, in the reverse process of Algorithm 2, the ϵ_{C} are used as the initially noise input to seed the generative diffusion process. This means the initial input exhibits a distribution with a frequency-specific variance (in contrast to a conventional white noise initialization, which by definition has a standard Gaussian frequency distribution). More generally, in Algorithm 2, the initial noise distribution is dependent on a predetermined variance per signal band for a known data modality to be synthesized (e.g. image, audio, volumetric etc.), which in some cases is precomputed from the training set itself and other cases is precomputed from a statistical analysis of other data samples representative of the known data modality to be synthesised. Likewise, in Algorithm 1, in other implementations, the covariance used to determine the level of frequency-dependent denoising per noise band is computed from representative data other than the training set S itself.

For each step t from T down to 1, the algorithm computes an estimate of an original sample, denoted

$${F}^{- 1} {y}_{0}^{( 1 )} .$$

At inference, this “original” sample is a synthetic sample generated from a noisy input (e.g. initial pure noise). This estimate is obtained by applying an inverse Fourier transform F⁻¹ to yₜ, feeding the result to the neural network f_{θ} at time t, and then performing a forward Fourier transform F on the network's output:

$${\hat{y}}_{0}^{( t )} = ( F ∘ {f}_{θ} ) ( {F}^{- 1} ( {y}_{t} ) , t ) .$$

In the above, α̅ₜ is a quantity that represents a cumulative product of the {αₜ} schedule up to step t, ensuring consistent scaling of noise and signal at each iteration.

An updated sample yₜ₋₁ is given by

$${y}_{t - 1} = \sqrt{{\overline{α}}_{t - I}} {\hat{y}}_{0}^{( t )} + \frac{\sqrt{1 - {\overline{α}}_{t - 1}}}{\sqrt{1 - {\overline{α}}_{t}}} ( {y}_{t} - \sqrt{{\overline{α}}_{t}} {\hat{y}}_{0}^{( t )} ) ,$$

which progressively removes noise in the frequency domain. After the final iteration, the result

$${y}_{0}^{( 1 )}$$

is the denoised sample in Fourier space, ready to be transformed back to the original domain using F⁻¹.

Algorithm 2 thus adapts the Denoising Diffusion Implicit Models (DDIM) sampling algorithm to Fourier space. Although the above analysis of the normality assumption was for the stochastic reverse process of DDPM, even though DDIM is deterministic, a similar property holds here, which results in poor generation quality for aggressively noised frequencies.

To compare performance across different forward processes, the processes are calibrated by ensuring that the average SNR across frequencies at any given timestep is the same. This means that the average amount of information destroyed across frequencies at timestep t is the same across these processes.

The base distribution noise (ϵ_{C})ⱼ used in both algorithms are computed as follows. Each entry (ϵ_{C})ⱼ is formed by taking the jth diagonal variance value cⱼ from the covariance matrix C and generating a complex Gaussian noise term whose real and imaginary parts both follow [symbol] (0,1). Concretely,

$${( {ϵ}_{C} )}_{j} = \frac{\sqrt{{c}_{j}}}{\sqrt{2}} ( ϵ + i {ϵ}^{′} ) ,$$

where ϵ and ϵ′ are independent standard normals. This ensures that the resultant magnitude aligns with cⱼ. The condition (ϵ_{C})ⱼ=(ϵ_{C})_{d-j} enforces Hermitian symmetry so that the final inverse Fourier transform produces real-valued data in the original domain.

In Algorithm 2, a covariance matrix of the training set S in Fourier space is used, as this defines the base distribution noise ϵ_{C}. The matrix C used in Algorithm 2 is a diagonal matrix containing only variances of the training set in Fourier space, or in other words, a diagonal of the (full) covariance matrix in Fourier space. In other embodiments, however, the full covariance matrix in Fourier space is used instead. Hence, the covariance of the training set S is directly used at inference in Algorithm 2. In both Algorithm 1 and Algorithm 2, the variance of each signal band is given by the diagonal component of C corresponding to the frequency band.

In some embodiments, the Fourier transform F is a fast Fourier transform (FFT), and its inverse is applied as an inverse FFT (IFFT).

The efficacy of the novel approach has been tested empirically.

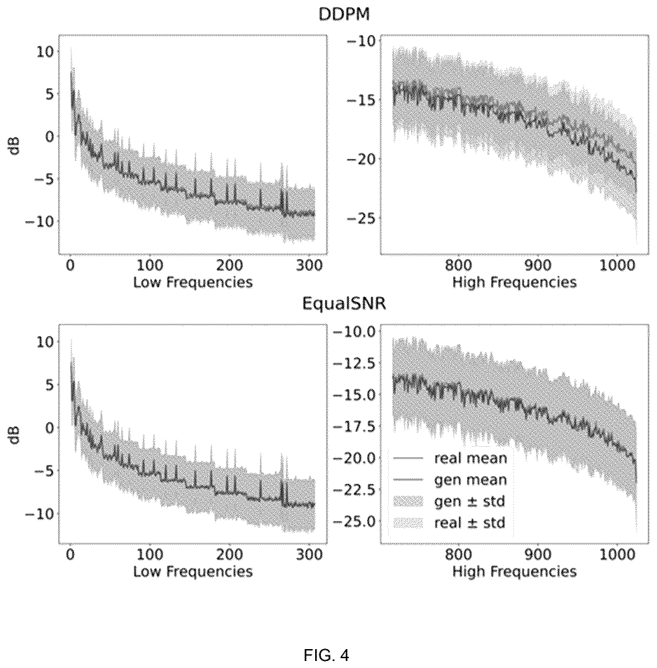

FIG. 4 presents spectral magnitude profiles in decibels for low and high frequencies, comparing data generated by DDPM and EqualSNR to real data. It shows that EqualSNR achieves more faithful generation of high-frequency components, aligning closely with the real distribution and surpassing DDPM in preserving fine details.

Table 1 summarizes the classifier analyses at different significance levels (0.05 and 0.01), measuring how easily high-frequency components can be differentiated from real data. It demonstrates that EqualSNR's high-frequency outputs are far less distinguishable than those of DDPM, highlighting EqualSNR's advantage in accurately modeling higher frequencies.

TABLE 1

| Method | Freq. band | Mean Acc. | % TP at 0.05 | % TP at 0.01 |
|---|---|---|---|---|
| DDPM | 5% | 0.624 | 99% | 99% |
| DDPM | 15% | 0.643 | 100% | 99% |
| DDPM | 25% | 0.654 | 100% | 100% |
| EqualSNR | 5% | 0.516 | 13% | 5% |
| EqualSNR | 15% | 0.521 | 16% | 1% |
| EqualSNR | 25% | 0.518 | 10% | 5% |

### Example Implementation Hardware

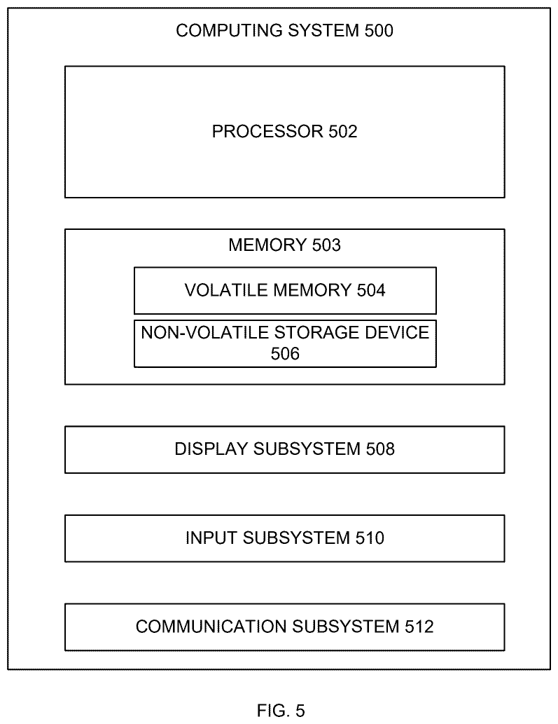

FIG. 5 schematically shows an example of a computer system 400, such as a computing device or system of connected computing devices configured to implement the diffusion model of FIG. 1, or the method of FIG. 2 or FIG. 3 (or any combination thereof).

The computer system 500 is shown in simplified form. The computer system 500 comprises a processor 502 and a memory 503. In this example, the memory 503 is shown to comprise volatile memory 504 and a non-volatile storage 506. In this example, the computer system 500 includes a display subsystem 508, an input subsystem 510, and a communication subsystem 512. In other examples, one, some or all of these components 508, 510, 512 are omitted. The processor 502 comprises one or more hardware processing units configured to carry out processing operations. A hardware processing unit may be programmable or non-programmable. Certain hardware processing units are configured to execute computer-readable instructions based on an instruction set architecture. Examples of such a hardware processing unit include a central processing unit (CPU), graphics processing unit (GPU), tensor processing unit (TPU), neural processing unit (NPU), intelligence processing unit (IPU) or other form of accelerator processing unit. Such hardware processing units may be single-core or multi-core, and instructions executed thereon may be configured for sequential, parallel, and/or distributed processing. Other examples of such hardware processing units include a field-programmable gate array (FPGAs) or a non-programmable fixed-logic circuit, such as an application-specific integrated circuit (ASIC). The processor 502 is contained in a single device in some examples. Individual components of the processor 502 are distributed among two or more separate devices in other examples. In some such examples, such devices are remotely located from each other and/or configured for coordinated processing. The non-volatile storage 506 includes one or more physical devices configured to hold data and/or computer-readable instructions executable by the processor 502. Examples of non-volatile storages include optical memory (e.g., CD, DVD, HD-DVD, Blu-Ray Disc, etc.), semiconductor memory (e.g., ROM, EPROM, EEPROM, FLASH memory, etc.), magnetic memory (e.g., hard-disk drive), or other mass storage device technology. The volatile memory 504 includes one or more physical devices that include random access memory in some examples. The volatile memory 504 is typically utilized by processor 502 to temporarily store data and/or instructions during processing. The terms “module,” “program,” and “engine” are used to describe particular functionality of the computer system 500 implemented in hardware or software. In some examples, a software module, program, or engine is instantiated via the processor 502 executing instructions held by non-volatile storage 506, using portions of the volatile memory 504. Different modules, programs, and/or engines are instantiated from the same application, service, code block, object, library, routine, API, function, etc. in some examples. In other examples, the same module, program, and/or engine are instantiated by different applications, services, code blocks, objects, routines, APIs, functions, etc. The terms “module,” “program,” and “engine” encompass among other things individual or groups of executable files, data files, libraries, drivers, scripts, database records, etc. The display subsystem 508 is configurable to present a visual representation of data such as data held by the non-volatile storage 506. The visual representation takes the form of a graphical user interface (GUI) in some examples. The display subsystem 508 includes one or more display devices utilizing virtually any type of technology. Such display devices are combined with processor 502, volatile memory 504, and/or non-volatile storage 506 in a shared enclosure in some examples. In other examples, such display devices are peripheral display devices. The input subsystem 510 comprises or interfaces with one or more input devices such as user-input devices such as a keyboard, mouse, touch screen, or game controller. In some embodiments, the input subsystem 510 comprises or interfaces with selected natural user input (NUI) componentry. Such componentry may be integrated or peripheral, and the transduction and/or processing of input actions may be handled on-board or off-board. Examples of NUI componentry include without limitation a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. The communication subsystem 512 is configured to communicatively couple the computer system 500 to another device or system. The communication subsystem 512 may include wired and/or wireless communication devices compatible with one or more different communication protocols. In some examples, the communication subsystem 512 allows computer system 500 to send and/or receive messages to and/or from other devices via a communication network such as the internet. The term computer readable media as used herein includes for example computer storage media. Computer storage media includes for example volatile and non-volatile, removable and nonremovable media (e.g., volatile memory 504 or non-volatile storage 506). Computer storage media includes for example solid-state storage, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g., the computer system 500 or a component device thereof). Computer storage media does not include a carrier wave or other propagated or modulated data signal. Communication media is embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. Examples of communication media include without limitation wired media such as a wired network or direct wired connection, and wireless media such as acoustic, radio frequency (RF), infrared, and other wireless media.

A first aspect herein provides a computer-implemented method of training a denoising model, the method comprising: receiving a training sample; converting the training sample into a frequency-domain representation; applying: a first frequency-specific degradation to a first frequency band of the frequency-domain representation based on a first variance of the first frequency band, and a second frequency-specific degradation to a second frequency band of the frequency-domain representation based on a second variance of the second frequency band, resulting in a degraded frequency-domain representation; and training the denoising model to reconstruct the frequency-domain representation based on the degraded frequency-domain representation, resulting in a trained denoising model.

In embodiments, the training sample comprises image data, audio data, video data, a molecular, protein or material structure, volumetric data, point cloud data, or sensor data.

In embodiments, the method comprises computing a covariance matrix based on data samples representative of a data modality of the training sample, wherein the variance of the first frequency band is determined as a first diagonal component of the covariance matrix corresponding to the first frequency band, and the variance of the second frequency band is determined as a second diagonal component of the covariance matrix corresponding to the second frequency band.

In embodiments, the training sample is one of multiple training samples used to train the denoising model, wherein the covariance matrix is computed based on the training samples.

In embodiments, the covariance matrix exhibits a Fourier power law.

In embodiments, the frequency-specific degradation is applied using a base distribution noise sampled from a normal distribution scaled to match the variance of the frequency band.

In embodiments, the denoising model is trained using a loss function that measures difference between the frequency-domain representation and a reconstructed frequency-domain representation generated using the denoising model based on the degraded frequency-domain representation.

In embodiments, the loss function is scaled by the covariance matrix.

In embodiments, the method comprises applying an inverse Fourier transform to the degraded frequency-domain representation, resulting in a degraded sample; inputting the degraded sample to the denoising model, resulting in a reconstructed sample; and applying a Fourier transform to the reconstructed sample, resulting in the reconstructed frequency-domain representation.

In embodiments, the Fourier transform is a fast Fourier transform (FFT), and the inverse Fourier transform is an inverse FFT.

A second aspect herein provides a computer system for generating synthetic data samples of a known data modality, the computer system comprising a processor and a memory coupled to the processor and storing instructions that, when executed by the processor, cause the computer system to generate an initial noisy frequency-domain representation exhibiting a distribution with frequency-specific variance across multiple frequency bands, in which a noise level in each frequency band is dependent on a variance associated with the frequency band precomputed for the known data modality; applying denoising to each frequency band, using a trained denoising model, resulting in a denoised frequency-domain representation; and generating a synthetic data sample of the known data modality based on the denoised frequency-domain representation.

In embodiments, the synthetic data sample comprises synthetic image data, synthetic audio data, synthetic video data, a synthetic molecular, protein or material structure, synthetic volumetric data, synthetic point cloud data, or synthetic sensor data.

In embodiments, the computer system comprises computing the variance of each frequency band based on data samples representative of the predetermined data modality.

In embodiments, the data samples representative of the predetermined data modality have been used to train the trained denoising model.

In embodiments, the variance of each frequency band is determined, based on a covariance matrix associated with the known data modality, as a diagonal component of the covariance matrix corresponding to the frequency band.

In embodiments, the covariance matrix exhibits a Fourier power law.

In embodiments, the initial noisy frequency-domain representation is determined using a base distribution noise sampled for each frequency band from a normal distribution scaled to match the variance of the frequency band.

A third aspect herein provides a computer-readable storage medium comprising computer-readable instructions configured, when executed by a processor, to cause the processor to perform operations of receiving a training sample; converting the training sample into a frequency-domain representation; applying a first frequency-specific degradation to a first frequency band of the frequency-domain representation based on a first variance of the first frequency band, and a second frequency-specific degradation to a second frequency band of the frequency-domain representation based on a second variance of the second frequency band, resulting in a degraded frequency-domain representation; and training the denoising model to reconstruct the frequency-domain representation based on the degraded frequency-domain representation, resulting in a trained denoising model.

In embodiments, the training sample comprises image data, audio data, video data, a molecular, protein or material structure, volumetric data, point cloud data, or sensor data.

In embodiments, said operations comprise computing a covariance matrix based on data samples representative of a data modality of the training sample, wherein the variance of the first frequency band is determined as a first diagonal component of the covariance matrix corresponding to the first frequency band, and the variance of the second frequency band is determined as a second diagonal component of the covariance matrix corresponding to the second frequency band.

The embodiments described above are illustrative and not exhaustive. Further embodiments are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the present disclosure. The scope is not defined by the described embodiments but only by the accompanying claims.

1. A computer-implemented method of training a denoising model, the method comprising:
receiving a training sample;
converting the training sample into a frequency-domain representation;
applying:
a first frequency-specific degradation to a first frequency band of the frequency-domain representation based on a first variance of the first frequency band, and
a second frequency-specific degradation to a second frequency band of the frequency-domain representation based on a second variance of the second frequency band,
resulting in a degraded frequency-domain representation; and
training the denoising model to reconstruct the frequency-domain representation based on the degraded frequency-domain representation, resulting in a trained denoising model.

2. The method of claim 1, wherein the training sample comprises:
image data,
audio data,
video data,
a molecular, protein or material structure,
volumetric data,
point cloud data, or
sensor data.

3. The method of claim 1, comprising computing a covariance matrix based on data samples representative of a data modality of the training sample, wherein the variance of the first frequency band is determined as a first diagonal component of the covariance matrix corresponding to the first frequency band, and the variance of the second frequency band is determined as a second diagonal component of the covariance matrix corresponding to the second frequency band.

4. The method of claim 3, wherein the training sample is one of multiple training samples used to train the denoising model, wherein the covariance matrix is computed based on the training samples.

5. The method of claim 3, wherein the covariance matrix exhibits a Fourier power law.

6. The method of claim 1, wherein the frequency-specific degradation is applied using a base distribution noise sampled from a normal distribution scaled to match the variance of the frequency band.

7. The method of claim 1, wherein the denoising model is trained using a loss function that measures difference between the frequency-domain representation and a reconstructed frequency-domain representation generated using the denoising model based on the degraded frequency-domain representation.

8. The method of claim 7, wherein the loss function is scaled by the covariance matrix.

9. The method of claim 7, comprising:
applying an inverse Fourier transform to the degraded frequency-domain representation, resulting in a degraded sample;
inputting the degraded sample to the denoising model, resulting in a reconstructed sample; and
applying a Fourier transform to the reconstructed sample, resulting in the reconstructed frequency-domain representation.

10. The method of claim 9, wherein the Fourier transform is a fast Fourier transform (FFT), and the inverse Fourier transform is an inverse FFT.

11. A computer system for generating synthetic data samples of a known data modality, the computer system comprising:
a processor; and
a memory coupled to the processor and storing instructions that, when executed by the processor, cause the computer system to:
generate an initial noisy frequency-domain representation exhibiting a distribution with frequency-specific variance across multiple frequency bands, in which a noise level in each frequency band is dependent on a variance associated with the frequency band precomputed for the known data modality;
applying denoising to each frequency band, using a trained denoising model, resulting in a denoised frequency-domain representation; and
generating a synthetic data sample of the known data modality based on the denoised frequency-domain representation.

12. The computer system of claim 11, wherein the synthetic data sample comprises:
synthetic image data,
synthetic audio data,
synthetic video data,
a synthetic molecular, protein or material structure,
synthetic volumetric data,
synthetic point cloud data, or
synthetic sensor data.

13. The computer system of claim 11, comprising computing the variance of each frequency band based on data samples representative of the predetermined data modality.

14. The computer system of claim 11, wherein the data samples representative of the predetermined data modality have been used to train the trained denoising model.

15. The computer system of claim 11, wherein the variance of each frequency band is determined, based on a covariance matrix associated with the known data modality, as a diagonal component of the covariance matrix corresponding to the frequency band.

16. The computer system of claim 15, wherein the covariance matrix exhibits a Fourier power law.

17. The computer system of claim 11, wherein the initial noisy frequency-domain representation is determined using a base distribution noise sampled for each frequency band from a normal distribution scaled to match the variance of the frequency band.

18. A computer-readable storage medium comprising computer-readable instructions configured, when executed by a processor, to cause the processor to perform operations of:
receiving a training sample;
converting the training sample into a frequency-domain representation;
applying:
a first frequency-specific degradation to a first frequency band of the frequency-domain representation based on a first variance of the first frequency band, and
a second frequency-specific degradation to a second frequency band of the frequency-domain representation based on a second variance of the second frequency band,
resulting in a degraded frequency-domain representation; and
training the denoising model to reconstruct the frequency-domain representation based on the degraded frequency-domain representation, resulting in a trained denoising model.

19. The computer-readable storage medium of claim 18, wherein the training sample comprises:
image data,
audio data,
video data,
a molecular, protein or material structure,
volumetric data,
point cloud data, or
sensor data.

20. The computer-readable storage medium of claim 18, said operations comprising computing a covariance matrix based on data samples representative of a data modality of the training sample, wherein the variance of the first frequency band is determined as a first diagonal component of the covariance matrix corresponding to the first frequency band, and the variance of the second frequency band is determined as a second diagonal component of the covariance matrix corresponding to the second frequency band.
